(19) United States
(12) Patent Application Publication
(10) Pub. No.: US 2019/0118130 A1
(43) Pub. Date: Apr. 25, 2019

(54) Grounded Filter System

(71) Applicant: LaGrange Products, Inc., Freemont, IN (US)

(72) Inventor: Mark Blue, Freemont, IN (US)

(73) Assignee: LaGrange Products, Inc., Freemont, IN (US)

(21) Appl. No.: 15/789,754

(22) Filed: Oct. 20, 2017

(51) Int. Cl. B01D 46/42; B01D 46/00

(52) U.S. Cl. CPC B01D 46/4209; B01D 46/0005; B01D 46/0004

(57) ABSTRACT

A filter system is provided having a housing with a removable cover. The housing and cover form an enclosed volume that receives a filter. The filter system has an inlet and an outlet. The filter filters fluid that passes from the inlet to the outlet. A threaded bolt having a spring is located in the cover and the spring makes electrical connection to the filter. A portion of the bolt extends through the cover to provide an electrical connection from the filter. A ground strap or other electrical connection is made to the portion of the bolt to ground the filter when it is located inside the enclosed volume.

### CROSS REFERENCE TO RELATED APPLICATIONS

This application claims priority of U.S. Provisional application 62/410,684, filed on Oct. 20, 2016, the entire disclosure of which is incorporated herein by reference.

### BACKGROUND OF THE INVENTION

Filtering flammable fluids is a necessary industrial process for certain applications. In some filtration applications air may be mixed with a flammable fluid or flammable vapor and that mixture is passed through a filter. When filtering a mixture of a flammable fluid and air there is a risk of fire that may begin with an electrical spark. As the mixture passes through the filter, a static charge may build and this can cause a spark that will ignite the mixture. The risk of a fire is mitigated by grounding the filter to prevent a static charge from building.

Existing filter grounding systems have attempted to ground the conductive filter through its contact with the interior of the housing and then grounded the housing to provide a conductive path. Any discontinuous contact of the filter element to the metal filter housing can leave a filter element ungrounded thus, permitting a charge to build and potentially lead to spark. A discontinuous ground can be caused by corrosion on an inner surface of the filter housing that is supposed to be in constant contact with the filter.

Springs biased against a filter within a housing have been used in an attempt to ground filters to the housing but have proved unreliable. In such a configuration, the spring located on the housing or filter may become bent and make no contact at all to electrically connect the housing and filter. In other cases, improper installation or tolerances may contribute to little or no contact between a filter spring and its housing. Any of the conditions mentioned above that allow a discontinuous contact between the filter element and the metal housing would be hidden and existing systems do not provide any indication whether the filter is actually grounded. There is a need for a filter having clear evidence of a properly grounded filter element and assurance that continuous contact across the pressure boundary of the filter housing will be present at all times.

### SUMMARY OF THE INVENTION

The invention includes a pressure vessel with a housing and a removable cover that is secured to the housing with fasteners. The removable cover and housing form a chamber with an inlet in fluid communication with an outlet. A filter element is located inside the chamber to filter fluid that passes between the inlet and outlet of the vessel. The filter has electrically conductive properties, either by being formed from conductive metal or including electrically conductive elements that are entrained in the filter media and/or other filter components.

The cover of said pressure vessel has an aperture that receives a threaded fastener. The threaded fastener is electrically conductive or has electrically conductive properties. It extends through the aperture and is sealed to the cover. The fastener is tightened to the cover with a nut. An external ground wire may be connected to the exposed portion of the fastener to ground the filter.

The fastener includes a spring or other electrically conductive component that is integrally electrically connected to the threaded fastener. When assembled, the spring is biased against the filter element to form an electrically conductive path from said filter through said threaded fastener. Other options to connect the fastener to the filter include a separate wire electrically connected between the fastener and the filter or combinations of the spring and separate wire.

### BRIEF DESCRIPTION OF THE DRAWINGS

FIG. 1 is an isometric view of a pressure vessel;

FIG. 2 is a sectional view of the pressure vessel shown in FIG. 1 along its diameter;

FIG. 3 is a side view of a grounding stud;

FIG. 4 is an isometric view of the grounding stud shown in FIG. 3;

FIG. 5 is a magnified view of the cover area shown in FIG. 2;

FIG. 6 is a sectional view of a second embodiment of the grounding stud having a central grounding wire through the center of the stud;

FIG. 7 is a magnified view of the cover area shown in FIG. 6;

FIG. 8 is a sectional view of a pressure vessel using a filter element having no end caps that seals directly to the pressure vessel; and

FIG. 9 is a sectional view of another pressure vessel using a filter element having a sidewall that seals around the inlet directly to the housing.

### DETAILED DESCRIPTION OF THE INVENTION

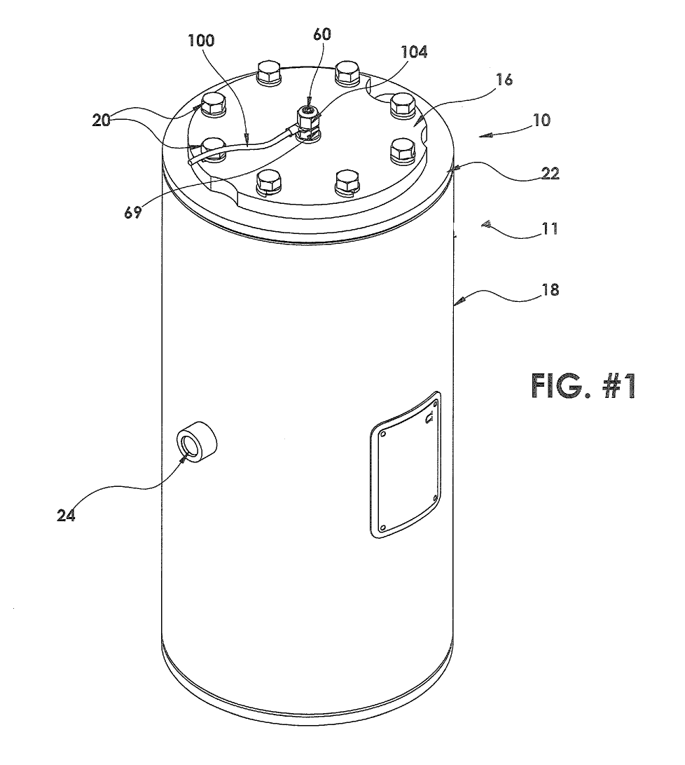

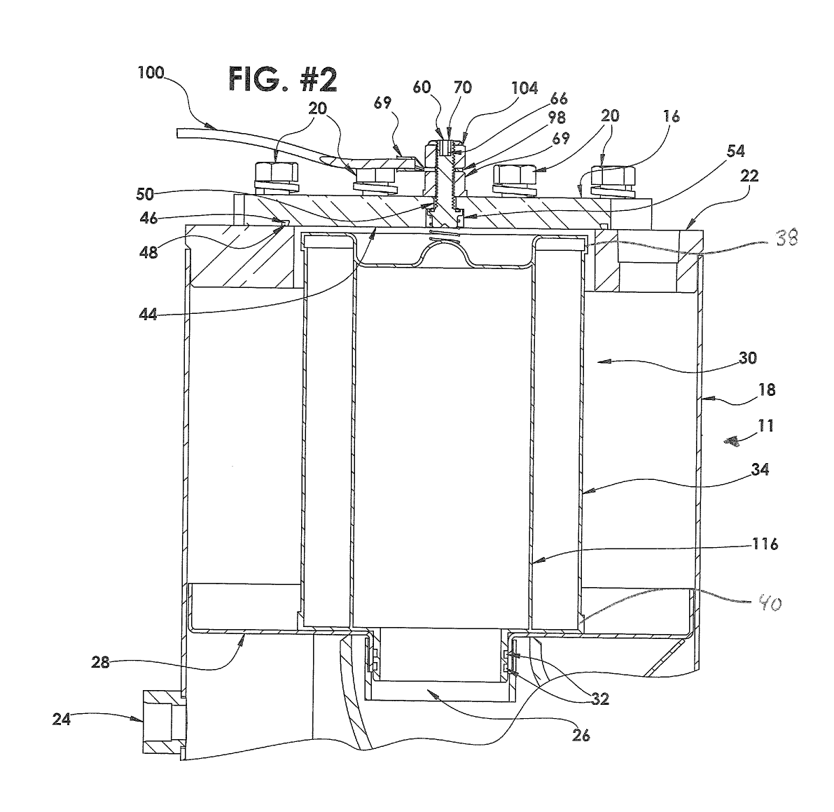

The filter system 10 of the present invention has a pressure vessel 11 that is shown in FIG. 1 and FIG. 2. FIG. 2 shows a sectional view of the filter system 10 of the present invention that has a pressure vessel 11 with a cover 16 sealingly mounted to a housing 18. The cover 16 is attached with bolts 20 that are threaded into blind holes (not shown) in the vessel flange ring 22 of the housing 18. The blind holes do not provide a potential leak path because they do not extend through the vessel flange ring 22. Fluid to be filtered enters an inlet 26 that is best seen in FIG. 2 and exits the outlet 24 through the bottom wall 28 of the housing 18. A filter element 30 is sealingly mated to the housing 18 between the inlet 26 and outlet 24 with O-rings 32 that seal against the inside of the inlet 26 as shown in FIG. 2. The filter element 30 has a sidewall 34 that is made of a filtering medium. In this case, the sidewall 34 of the filter element is electrically conductive. The electrical conductivity of the sidewall 34 may be due to the composition of the filtering medium itself, but in the case that the filtering medium is a non-conductive material (such as glass or polymer fiber), the sidewall 34 derives its conductive property by the inclusion of a conductive element such as a wire mesh support within or on the sidewall 34 that provides the electrically conductive property. The sidewall 34 is retained between an upper end cap 38 and a lower end cap 40. The upper end cap 38 is made of metal and conductively bonded to the sidewall 34 so that electricity may flow from the filter medium of the sidewall 34 to the upper end cap 38. Fluid entering the inlet 26 must pass through the sidewall 34 of the filter element 30 to exit the outlet 24.

The cover 16 has an inner surface 44 that mates with the vessel flange ring 22 of the housing 18. The cover 16 has a groove 46 that receives an O-ring 48 to provide a fluid tight seal between the vessel flange ring 22 and the cover 16, as shown in FIG. 2. The pressure vessel 11 forms a pressure boundary and an aperture 50 extends through the cover 16 and has a countersunk pocket 54 having a bottom 55 that is offset from the inner surface 44 of the cover 16.

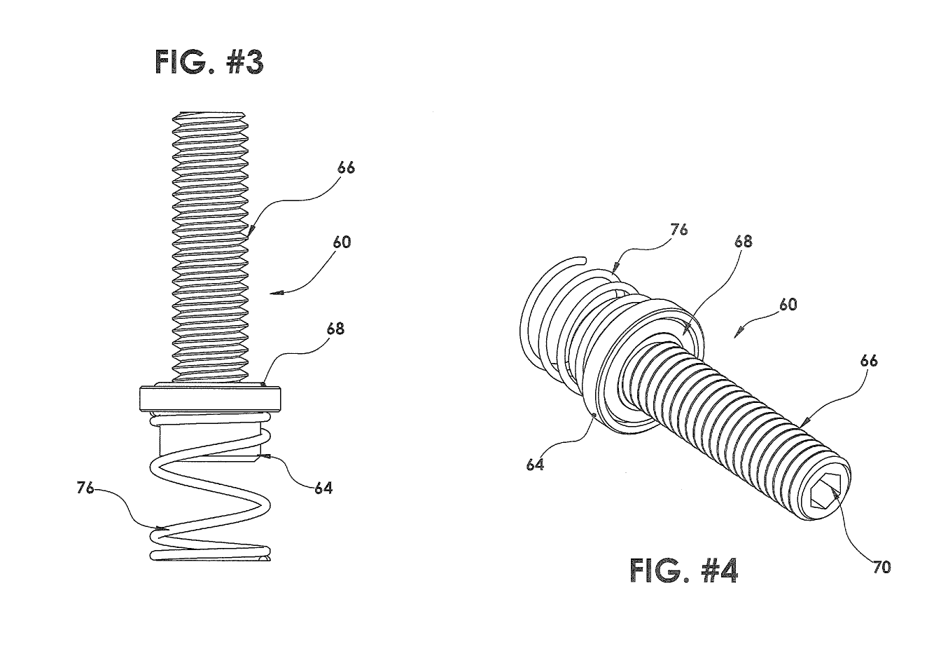

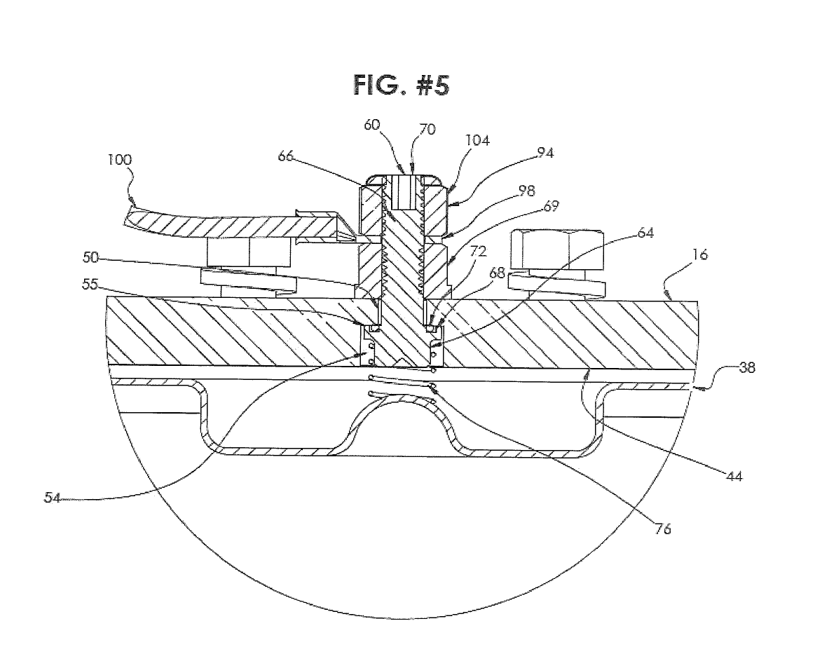

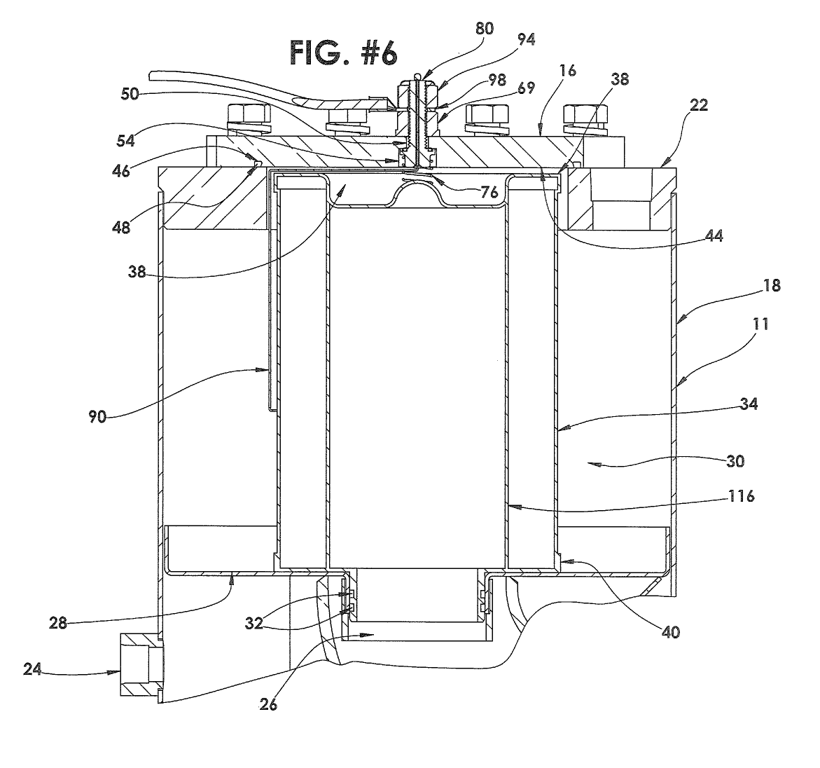

A stud 60, shown in FIGS. 3 and 4, having a head 64 and a threaded shaft 66 extends through the aperture 50. The stud 60 is shown sectioned in magnified detail in FIG. 5. The head 64 of the stud 60 adjacent to the shaft 66 has a groove 68 that circumscribes the shaft 66 and receives an O-ring 72. The O-ring 72 seals to the cover 16 to maintain the integrity of the pressure vessel 11 and thus, the only part of the filter system 10 that extends through the pressure boundary of the pressure vessel 11 is the shaft 66 of the stud 60. The head 64 of the stud 60 may be an internal hex to receive a hex key (commonly known as an allen wrench) or hex head type that would be driven by a socket or wrench. The end of the shaft 66, opposite the head 64, is shown as a hex socket 70 for receiving an allen wrench that may be used to prevent rotation of the stud 60 when tightening nut 69 onto the shaft 66. It is also contemplated that opposing flats near the end of the shaft 66 could be used as an anti-rotation feature instead of the hex socket 70. On the head 64, opposite the O-ring 72 is a spring 76 that is integrally attached to the stud 60. This attachment may be done through welding, brazing, or soldering. Other options include press fit, crimping, swaging, riveting, or stamping. In any method of attachment, the connection to the stud 60 is done in a manner that provides a continuous electrical conductive path through the spring 76 and stud 60. In many applications, it is desirable to have the spring 76 be of a corrosion resistant material such as stainless steel.

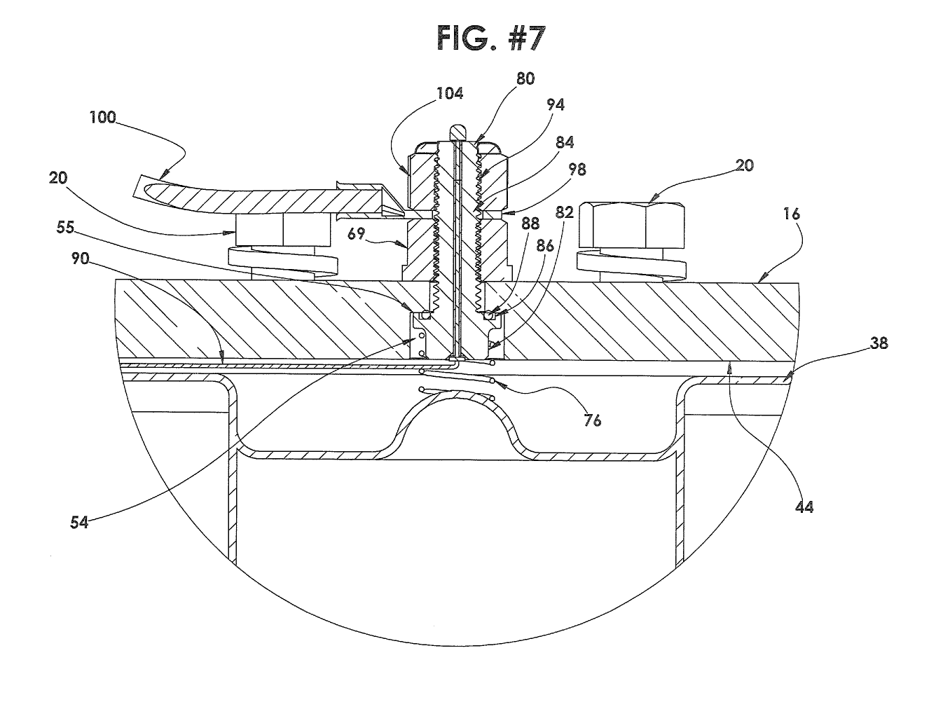

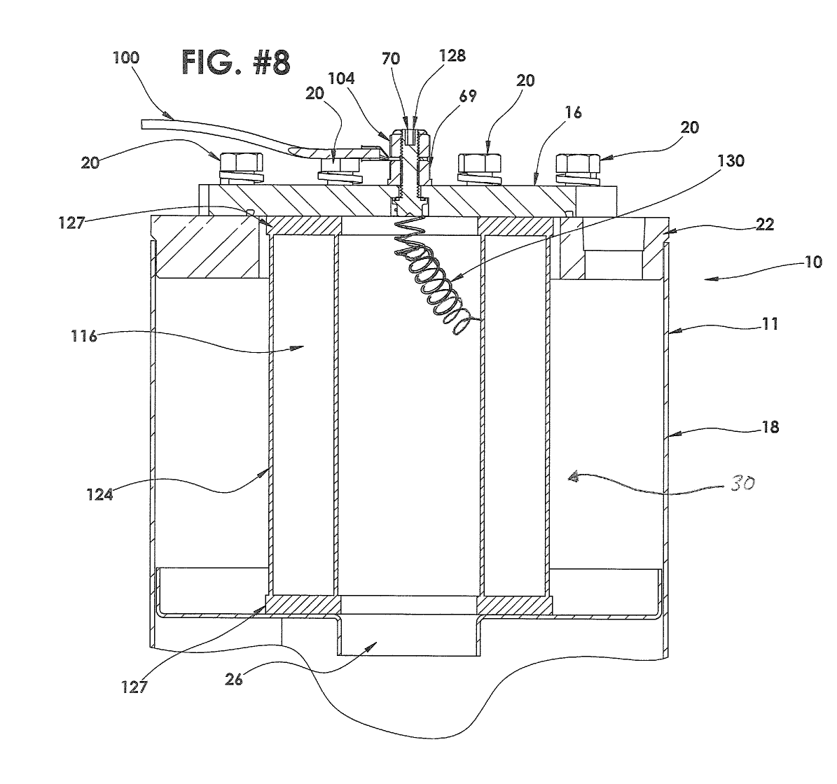

In addition to the stud 60 shown in FIGS. 6 and 7, an alternative embodiment having stud 80 is shown in FIGS. 6 and 7. This stud 80 has a head 82, shaft 84, and groove 86 for receiving an O-ring 88. Unlike stud 60, stud 80 has a center wire 90 that extends through the center of the stud 80 and that center wire 90 is electrically insulated from the stud 80. The center wire 90 is sealed to the stud 80. The center wire 90 extends into the housing 18 and is connected to a location on the filter element 30 at a location remote from the upper end cap 38. As shown in FIG. 6, that connection of the center wire 90 is made directly to the sidewall 34 made of electrically conductive metallic medium. The opposite end of the center wire 90 may be connected to a location remote from the pressure vessel 11 for grounding. Like stud 60, stud 80 is attached to the cover 16 by tightening nut 69 onto its shaft 84. The configuration shown in FIGS. 6 and 7 has a dual ground to the filter element 30. As a first ground, the center wire 90 is grounded to the sidewall 34 of the filter element 30. As a second ground, the spring 76 contacts the upper end cap 38. The filter element 30 provides a continuous conductive path from the location where the center wire 90 is grounded to the sidewall to the upper end cap 38 because the upper end cap 38 and sidewall 34 are both electrically conductive materials. Thus, if the filter element 30 is properly grounded by its connection between the spring 76 and upper end cap 38, there will be a continuous circuit from the stud 80 to the center wire 90. This continuity between the stud 80 and center wire 80 can be verified with a continuity tester to verify that the filter element 30 is properly grounded.

In the case of either stud 60, 80 the shaft 66, 84 receives a terminal end 98 of a main grounding wire 100. The main grounding wire 100 is connected to a location remote to that of the pressure vessel 11 that effectively grounds the pressure vessel 11. The nut 69 contacting the cover 16 is a serrated face nut that digs into the cover 16 and the terminal end 98 of the main grounding wire 100 is pinched between a corresponding nut 69 and a jamb nut 104. The fact that the nut 69 digs into the cover 16 when it is tightened ensures that the pressure vessel 11 is grounded as well as the filter element 30. The jamb nut 104 includes a nylon insert as shown in FIGS. 2, 5, 6, and 7, but could be any other type of prevailing toque fastener that resists loosening.

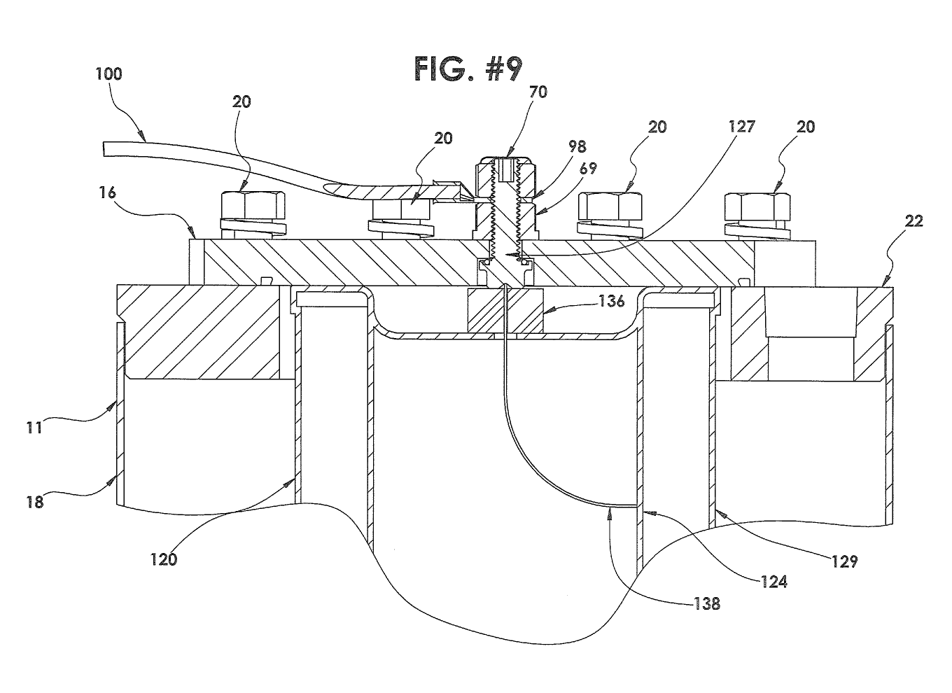

The filter system 10 is compatible with different types of filter elements such as the filter element 116 shown in FIG. 8. In the case of the filter element in FIG. 8, no end caps are present as in the filter element 30. The sidewall 124 of filter element 116 is sealed directly to the pressure vessel 11 at opposite ends 127. In this case, grounding must be done directly to the sidewall 124. As such, the grounding stud 128 is configured similarly to the aforementioned grounding studs 60, 80, but a grounding member 130 is attached to the stud 128 and directly connected to the sidewall 124. In FIG. 8, the grounding member 130 may be a length of spring or other flexible electrically conductive part. As shown in FIG. 8, a bent length of spring 130 serves as the grounding member that is attached to the sidewall 124 of the filter element 116. The attachment of the grounding member 130 may be accomplished by welding, brazing, or soldering its ends to the stud 128 and to the sidewall 124 of filter element 116.

The filter element 120 shown in FIG. 9 includes a non-electrically conductive rubber cap 136 through which a grounding member 138 extends and is connected between grounding stud 127 and the sidewall 129. In this case, the rubber cap 136 provides a support for the stud 127 to rest upon when the filer element 120 is installed in the housing 18.

A user of the filter system 10 will first install the filter element 30, 116, or 120 into the housing as shown in FIG. 2, 6, 7 or 8. Once the filter element 30 is installed, the cover 16 is placed over the stud 60, 80 with the spring contacting the upper end cap 38 of the filter element 30, in the case that filter element 30 is used. In the case that filter element 116 or 120 is used with grounding stud 128, the grounding member 130, 138 will be directly grounded to the sidewall 124, 129. In the case of either type of stud 60, 80, 128 the nut 69 nearest the cover 16 is hand started onto the stud 60, 80, 128. The cover 16 is then installed onto the housing 18 and its bolts 20 are tightened. An allen wrench is used to prevent rotation of the stud 60, 128 and stud 80 is prevented from rotating by other means such as flats near the end opposite the head 82 so that the nut 69 may be tightened into firm contact with the cover 16. The terminal end 98 of the main grounding wire 100 is put onto the stud 60, 80 128 and the jamb nut 104 is tightened onto the stud 60, 80, 128. In the case of the stud 80, a continuity tester lead is placed on the stud 80 and the other end is connected to the center wire 90 to determine if a continuous circuit is established between the leads of the continuity tester. If a complete circuit is detected, the user is assured that the spring 76 is in good electrical contact with the upper end cap 38 of the filter element 30 and therefore, grounding the filter element 30. This configuration provides multiple paths for grounding the filter element 30. Use of the filter system 10 of the present invention provides only a single part (the stud 60, 80, 128) that extends through pressure boundary of the pressure vessel 11. As such, the potential for leakage is minimized, yet there is an affirmative showing that a secure ground has been made that is not possible with prior art systems where all of the parts serving the grounding function are contained and hidden within their pressure vessel.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A filter system comprising:
a vessel having a housing and a removable cover adapted for being secured to said housing to form a chamber, said chamber including an inlet in fluid communication with an outlet, and a filter element adapted for location in said chamber between said inlet and said outlet for filtering fluid passing between said inlet and said outlet, said filter element including an electrically conducting filter wall for passing fluid therethrough;
said cover of said vessel including an aperture extending therethrough;
a threaded fastener adapted for extending through said aperture and sealable to said cover, said threaded fastener being electrically conductive;
a spring integrally electrically connected to said threaded fastener and being electrically conductive, said spring adapted for being biased against said filter element to form an electrically conductive path from said filter through said threaded fastener.

2. The filter system of claim 1, wherein said threaded fastener receives a grounding wire affixable to said threaded fastener to electrically connect said grounding wire to said filter, said grounding wire mountable to a location remote from said vessel.

3. The filter system of claim 1, wherein said threaded fastener includes an electrically conductive wire extending therethrough, said electrically conductive wire being electrically insulated from said threaded fastener, said electrically conductive wire adapted for being in contact with said filter element at a location spaced from said spring.

4. The filter system of claim 1, wherein said threaded fastener is a stud having a head and a shaft, said shaft adapted for extending through said aperture and receiving a nut to affix said threaded fastener to said cover.

5. The filter system of claim 4, wherein said cover has an inner surface, and said inner surface includes a countersunk pocket having a bottom, said countersunk pocket for receiving said head of said stud.

6. The filter system of claim 5, wherein said head of said stud includes a seal for sealing against said bottom of said countersunk pocket.

7. The filter system of claim 6, wherein said stud receives a grounding wire affixed thereto.

8. A grounded filter system comprising:
a vessel having a housing and a cover adapted for being secured to said housing to form a chamber, said chamber including an inlet in fluid communication with an outlet, and a filter element adapted for location between said inlet and said outlet for filtering fluid passing between said inlet and said outlet, said filter element including an electrically conducting filter wall for passing fluid therethrough; said filter element including an electrically conductive end cap adapted for being adjacent to said cover when said filter element is installed;
said cover of said vessel including an aperture;
a stud having a head and a shaft connected to said head, said shaft adapted for extending through said aperture and said head sealable to said cover, said shaft adapted for receiving a nut for fastening said stud to said cover, said stud being electrically conductive;
a spring integrally electrically connected to a threaded fastener and being electrically conductive, said spring adapted for being biased against said filter element when said filter element is located in said chamber to form an electrically conductive path from said filter through said threaded fastener.

9. The grounded filter system of claim 8, wherein said cover has an inner surface, and said inner surface includes a countersunk pocket having a bottom, said countersunk pocket for receiving said head of said stud.

10. The grounded filter system of claim 9, wherein said head of said stud includes a seal for sealing against said bottom of said countersunk pocket.

11. The grounded filter system of claim 10, wherein said stud receives a grounding wire to electrically connect said grounding wire to said filter element.

12. The grounded filter system of claim 11, wherein a jamb nut clamps said grounding wire against said nut to electrically connect said grounding wire to said stud.

13. A grounded filter system comprising:
a vessel having a housing and a cover adapted for being secured to said housing to form a chamber, said chamber including an inlet in fluid communication with an outlet, and a filter element adapted for location between said inlet and said outlet for filtering fluid passing between said inlet and said outlet, said vessel defining a pressure boundary, said filter element including an electrically conducting filter wall for passing fluid therethrough;
said vessel including an aperture extending through said vessel;
a stud adapted for extending through said aperture to a location outside of said pressure boundary and said stud being sealable to said vessel, said stud being electrically conductive;
an electrical conductor electrically connected to said stud and connected to said filter wall providing a continuous electrical path from said filter wall though said pressure boundary.

14. The grounded filter system of claim 13, wherein said stud is a bolt having a head and a shaft.

15. The grounded filter system of claim 14, wherein said head of said bolt includes a seal for sealing against said cover.
